(19) United States
(12) Patent Application Publication
(10) Pub. No.: US 2020/0034193 A1
(43) Pub. Date: Jan. 30, 2020

(54) MIGRATION OF CONTAINERIZED APPLICATIONS

(71) Applicant: HEWLETT PACKARD ENTERPRISE DEVELOPMENT LP, Houston, TX (US)

(72) Inventors: Smitha Jayaram, Bangalore (IN); Padmagandha Panigrahy, Bangalore (IN); Ranjani Nagarajan, Bangalore (IN); Vandana Basavanahalli Nagabhushana, Bangalore (IN); Anand Satish Phatak, Bangalore (IN)

(21) Appl. No.: 16/043,481

(22) Filed: Jul. 24, 2018

(51) Int. Cl. G06F 9/48; G06F 9/455; G06F 9/50; G06F 3/06

(52) U.S. Cl. CPC G06F 9/4862; G06F 9/455; G06F 9/5077; G06F 3/0604; G06F 3/067; G06F 3/0644; G06F 3/0653

(57) ABSTRACT

In example implementations, a computing node is provided. The computing node includes a containerized application, a local storage partition, and a controller. A portion of the local storage partition is associated with portions of other local storage partitions to form a global cache. The controller executes the containerized application, receive an indication from a second computing node that the containerized application is being migrated, transfers data associated with the containerized application to the second computing node via the global cache.

### BACKGROUND

The adaptation of containerized applications is expanding due to the ease of deployment and flexibility the containerized applications provide. Containerized applications can be used for distributed application networks. The containerized application may include all the run-time components used to execute a particular application.

The containerized application can consume less resources than a virtualized application as the containerized application does not use a local operating system. Rather, the containerized application can be executed within the environment of the host operating system of a particular computing node. As a result, the containerized applications can provide more flexibility than the virtualized applications as they can be moved between computing nodes.

### BRIEF DESCRIPTION OF THE DRAWINGS

FIG. 1 is a block diagram of an example network of the present disclosure;

FIG. 2 is a block diagram of an example node of the present disclosure;

FIG. 3 is a block diagram of an example of a containerized application that is migrated to a different node;

FIG. 4 is a flow chart of an example method for migrating a containerized application; and

FIG. 5 is a block diagram of an example non-transitory computer readable storage medium storing instructions executed by a processor to migrate a containerized application.

### DETAILED DESCRIPTION

Examples described herein provide a method to migrate containerized applications. As discussed above, containerized applications provide advantages over virtualized applications. For example, the containerized applications can be moved between computing nodes.

However, when the containerized applications are moved, some data associated with the containerized applications may also be moved. Currently, the data may be stored in a network storage device at a layer below the computing nodes and host operating system. As a result, there may be some latency that is experienced when a containerized application is migrated due to the time to access and transfer the data in the network storage device.

The present disclosure provides an architecture and method to improve the input/output latency associated with migrating containerized applications across different computing nodes. In an example, an input/output (I/O) accelerator layer may be created across the computing nodes. The I/O accelerator layer may include a global cache that can be used to locally store and move data across computing nodes when migrating containerized applications. As a result, accessing persistent storage in a networked storage device can be avoided during migration of containerized applications and I/O latency can be avoided.

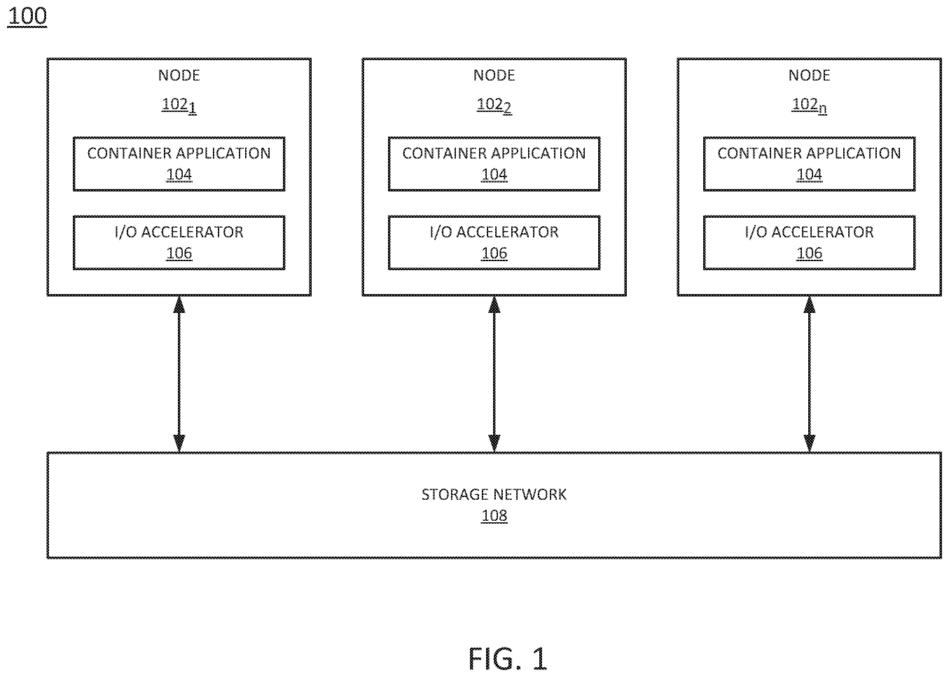

FIG. 1 illustrates a network 100 of the present disclosure. In an example, the network 100 may include a plurality of nodes 102₁ to 102ₙ (hereinafter also referred to individually as a node 102 or collectively as nodes 102). In an example, the nodes 102 may be computing nodes. The nodes 102 may include processing resources from a pool of available processing resources. In other words, the processing capability of each node 102 may come from a single processor or from a portion of a plurality of different processors.

In an example, the nodes 102 may operate under the control of a single underlying operating system (OS). For example, a host OS may control the applications executed by the processing resources of each node 102.

In an example, each one of the nodes 102 may include a containerized application 104 and an input/output (I/O) accelerator 106. The containerized application 104 may be an application that includes run-time instructions that can be quickly executed by any of the nodes 102. The containerized application 104 may be executed by the nodes 102 using the underlying host OS.

In other words, the containerized application 104 may be different than applications that are executed on virtual machines. For example, the applications executed on virtual machines may use an instance of a virtual OS executed within the node to execute the application. Thus, the containerized application 104 may require less processing resources than applications executed on virtual machines.

In addition, the design of the containerized application 104 may provide easier migration. For example, since the containerized application 104 can execute using the underlying host OS of the nodes 102, the containerized application 104 can be migrated to any one of the nodes 102₁ to 102ₙ.

The nodes 102 may also be communicatively coupled to a storage network 108. The storage network 108 may include computer readable storage mediums or database servers that can provide long term persistent storage of data. The storage network 108 may be a distributed file system (DFS).

In some examples, the containerized application 104 may include input/output operations. For example, the input/output operations may include write commands that may store data associated with the containerized application 104 in memory.

In previous designs, the data may be stored in the storage network 108. However, when the containerized application 104 would migrate to another node 102, transferring the data associated with the containerized application 104 may introduce a significant delay when the data was stored in the storage network 108. For example, the delays may be associated with time to request the data from the storage network 108 and transfer the data to the node 102 that received the migrating containerized application 104.

The present disclosure improves the efficiency of migrating the containerized application 104 such that the containerized application 104 may run “hot” on the new node 102 after migration. In other words, the containerized application 104 may be migrated to a different node 102 and begin execution immediately, or with little delay.

In an example, the nodes 102 may include the I/O accelerator 106, as noted above. The I/O accelerator 106 may intercept write commands issued by the containerized application 104 and execute the write commands in a local memory of the node 102. The I/O accelerator 106 may then transfer the data associated with the containerized application 104 to a different node 102 that receives the containerized application 104 that has migrated. Thus, the I/O accelerator 106 may allow data to be transferred without accessing the storage network 108.

Although FIG. 1 illustrates a single containerized application 104 being executed on each node 102, it should be noted that any number of containerized applications 104 may be executed on each node 102. In addition, the same number or a different number of containerized applications 104 may be executed on each node 102.

It should be also noted that FIG. 1 has been simplified for ease of execution. For example, the network 100 may include additional network devices and features that are not shown in FIG. 1. For example, the network 100 may include a load balancer, servers, processors, memory devices, and the like.

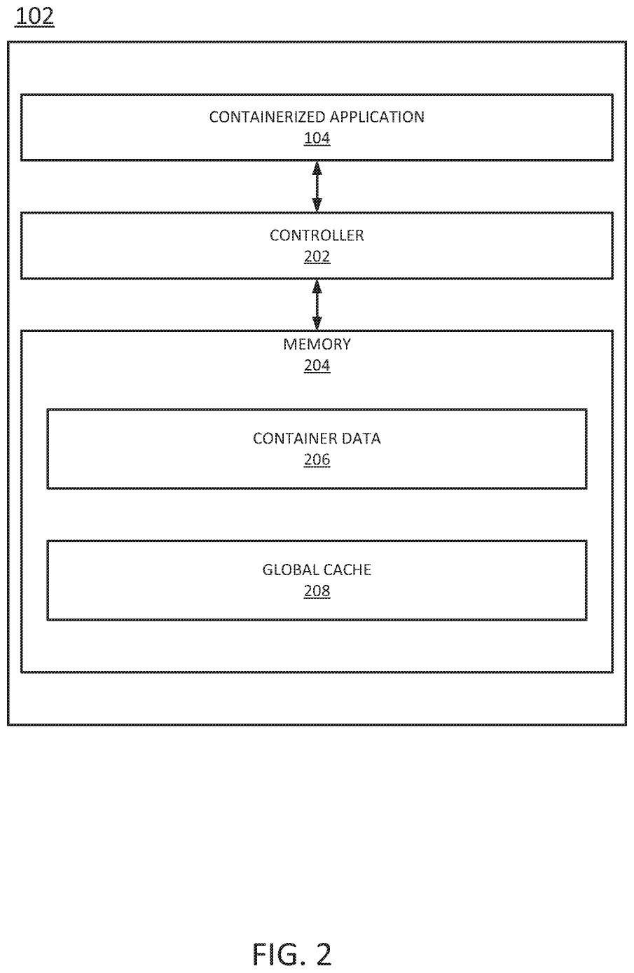

FIG. 2 illustrates a more detailed block diagram of an example node 102 of the present disclosure. In an example, the node 102 may include a controller 202 and a memory 204. The controller 202 may be a hardware controller. For example, the controller 202 may be a central processing unit (CPU), an application specific integrated circuit (ASIC) chip, or any other processing device. In an example, the controller 202 may be a combination of hardware and programming (e.g., a processor executing instructions stored in the memory 204). The node 102 may also include the containerized application 104, as discussed above. The controller 202 may be communicatively coupled to the memory 204 and execute the containerized application 104.

In an example, the memory 204 may be a local storage partition of available memory resources. For example, the node 102 may be a collection of processing resources of processors and memory resources of memory devices of different computing devices. Thus, the memory 204 may comprise a partition of different portions of local storage of the computing devices that form the node 102.

In an example, a portion of the memory 204 may form a global cache 208. In other words, each node 102 in the network 100 may have a portion of memory 204 set aside to be associated, or reserved to be used, with the global cache 208. The global cache 208 (which may also be referred to as a distributed cache 208) may allow data, such as a container data 206, to be transferred between nodes 102 in the network 100 without having to access the storage network 108. In an example, the I/O accelerator 106 illustrated in FIG. 1 may be comprised in hardware of the controller 202 and the global cache 208.

As a result, the containerized application 104 may be migrated more efficiently due to the faster transfer of data between the nodes 102. For example, the global cache 208 may use consensus protocols to transfer data, which may reduce overhead. Using the global cache 208 may also reduce the number of requests to the storage network 108, which may have longer access times than the portions of the local storage of the nodes 102 that form the global cache 208.

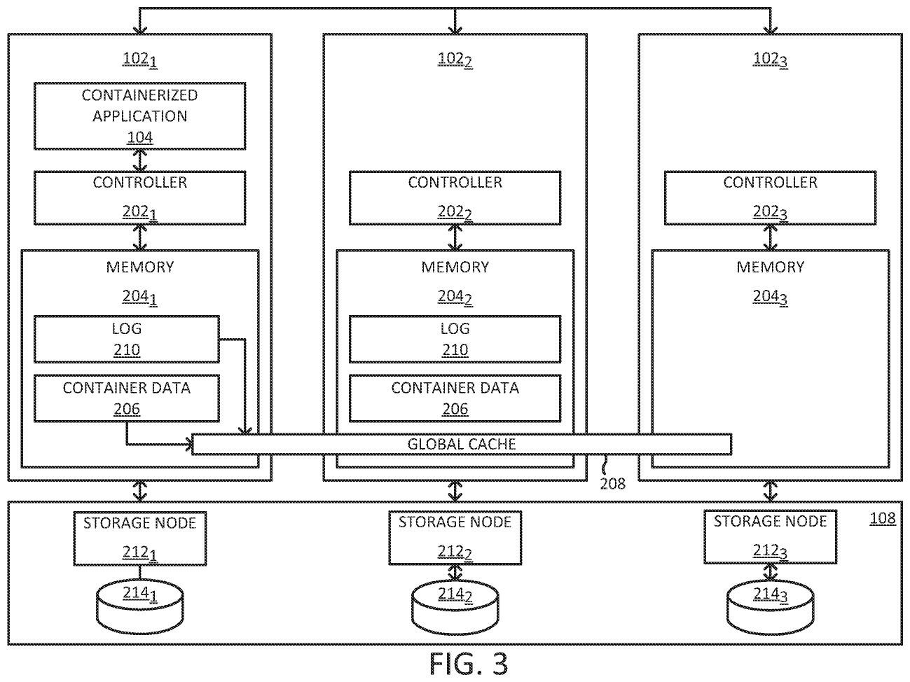

Access to the storage network 108 may also involve more storage allocation and metadata overhead, which can make small write operations more expensive. In contrast, the present disclosure may perform write operations to the log 210 (illustrated in FIG. 3) and many small write operations can be aggregated into a single large I/O operation to a pre-allocated log file. In addition, the global cache 208 may be comprised of faster storage media than the storage media in the databases 214 of the storage network 108 (illustrated in FIG. 3).

As discussed above, the containerized application 104 may be executed on the node 102. The container data 206 associated with the containerized application 104 may be stored in the memory 204 (e.g., a local partition or local memory of the node 102).

In an example, a target node, or second computing node, may detect the migration of the containerized application 104. In response to the detection, the controller 202 may be signaled by, or receive an indication (e.g., a migration message or notification) from, the target node to which the containerized application 104 is being migrated. The indication from the second computing node may also include a request for data associated with the containerized application 104 that has been migrated. The controller 202 may transfer the container data 206 to the second computing node via the global cache 208.

FIG. 3 illustrates a block diagram of an example of the containerized application 104 that is migrated to a different node. FIG. 3 illustrates three nodes 102₁, 102₂, and 102₃. In an example, the node 102₁ may initially execute the container application 104. The node 102₁ may include a controller 202₁ and a memory 204₁.

In an example, the memory 204₁ may include the container data 206 and a log 210. In an example, the log 210 may be part of the container data 206. The log 210 may provide a list of input/output operations that are executed by the containerized application 104. In other words, the log 210 may provide a current record of the processes executed by the containerized application 104. Thus, when the containerized application 104 is migrated, the log 210 may provide information to the new node regarding the current process being executed by the containerized application 104. As a result, the log 210 may help the new node execute the containerized application 104 seamlessly after migration.

In an example, a single log 210 may provide a list of input/output operations that are executed by a plurality of containerized applications 104. In other words, a single log 210 may hold data associated with many different containerized applications 104.

In an example, the memory 204₁ may include a plurality of logs 210 when a plurality of containerized applications 104 are executed by the same node 102₁. The log 210 may be associated with a containerized application identifier to identify which containerized application 104 is associated with which log 210.

The nodes 102₂ and 102₃ may include respective controllers 202₂ and 202₃ and respective memory 204₂ and 204₃. In an example, a portion of the memory 204₁, 204₂, and 204₃ may be associated with the global cache 208, as described above. The global cache 208 is illustrated in FIG. 3 as a channel connecting all three nodes 102₁, 102₂, and 102₃. However, it should be noted that the portions of the memory 204₁, 204₂, and 204₃ may be communicatively connected and not physically connected.

In an example, the storage network 108 may include a storage nodes 212₁-212₃ (hereinafter also referred to individually as a storage node 212 or collectively as storage nodes 212) and databases 214₁-214₃ (hereinafter also referred to individually as a database 214 or collectively as databases 214). The storage nodes 212 may be servers or computing devices that control access to and from the respective databases 214. The databases 214 may be computer readable storage media that provide persistent storage of data for the nodes 102₁, 102₂, and 102₃. As noted above, the storage nodes 212 and the databases 214 may be set up as a distributed file system.

In an example, the containerized application 104 may begin executing on the node 102₁. The input/output (I/O) commands (e.g., write commands or read requests) of the containerized application 104 may be intercepted by the controller 202₁. The example below may be described with reference to a write command, but it should be noted that the examples may apply to any I/O command.

The write command may be initially intended for a networked storage device in the storage network 108. However, after intercepting the write command, the write command may be executed in the memory 204₁ and stored in the container data 206. A record of the write command may be recorded in the log 210.

Periodically, the controller 202₁ may perform a destaging process to transfer the container data 206 to the storage network 108. For example, the memory 204₁ may become full and the previously stored container data 206 may be transferred to free space for newer container data. In an example, the controller 202₁ may be communicatively coupled to the storage node 212₁. The controller 202₁ may transmit the container data 206 to the storage node 212₁ to be stored in the database 214₁. The destaging may be performed as an asynchronous process.

In an example, the node 102₂ may be a replica node. For example, the controller 202₁ may be communicatively coupled to the node 102₂. All input/output operations of the containerized application 104 may be copied continuously to the memory 204₂ of the node 102₂. As a result, the node 102₂ may also store a copy of the container data 206 and the log 210. In an example, the input/output operations of the containerized application 104 may be transferred via the global cache 208 to the memory 204₂ of the node 102₂.

As discussed above, the present disclosure may provide more efficient migration of containerized applications 104 due to faster data transfer using the global cache 208. In addition, to the features described above, other optimizations in the replica node may be deployed. For example, within a time interval, the replica node can coalesce data pertaining to more than one containerized application 104 if the multiple containerized applications 104 all have respective logs 210 on the same node 102. This may reduce the number of I/Os going across the nodes 102.

In an example, the input/output operations executed by the containerized application 104 may be copied synchronously. For example, the input/output operations executed by the containerized application 104 may be copied continuously as they are executed to the memory 204₂ of the node 102₂. An input/output operation, such as a write operation, may be acknowledged after the write operation to the logs 210 of both nodes 102₁ and 102₂ is completed.

Thus, in an example, when the containerized application 104 is migrated to the node 102₂, the node 102₂ may already have the log 210 and the container data 206 as the replica node. The node 102₂ may immediately begin executing the containerized application 104 without delay. Thus, the migration of the containerized application 104 may be improved. Data that is stored in the database 214₁ may be transferred to the storage node 212₂ and the database 214₂ at a later time without delay in execution of the containerized application 104 on the node 102₂.

In another example, the containerized application 104 may be migrated to the node 102₃. The node 102₃ may not be a replica node. Thus, the node 102₃ may not have a copy of the container data 206 and the log 210. When the containerized application 104 is migrated to the node 102₃, the node 102₃ may detect the migration of the containerized application 104 and send a signal, an indication, or a notification to the node 102₁. The notification may include a request for the container data 206 associated with the containerized application 104 that has migrated.

For example, container volumes may be files on the host system. The I/O accelerator 106 may run as a filesystem client. The controller 202 that is part of the I/O accelerator 106 may maintain a mapping of the container ID to the filesystem unique identifier. For example, a command similar to a “docker inspect” command can be invoked from the controller 202 when a new filesystem unique identifier is inserted to map the actual path of the docker volume to its containerized application 104.

Once this information is stored by the controller 202, the information can be used to identify I/O operations from a specific containerized application 104. When a containerized application 104 moves, the controller 202 can detect this movement by validating the mapping between the container ID, the host ID and the filesystem unique identifier of a subsequent I/O operation request with what is stored by the controller 202. This way, data locality can be provided to an instance of a containerized application 104 as compared to other solutions, which may perform a process using virtual machines. In other words, the nodes 102 of the present disclosure provide a more granular solution than other processes.

In response, the controller 202₁ may transfer the container data 206 and the log 210 to the memory 204₃ via the global cache 208. It should be noticed that the controller 202₁ does not need to communicate with, or access data from, the storage network 108.

The node 102₃ may store the container data 206 and the log 210 in the memory 204₃. The controller 202₃ may read the log 210 to determine where the containerized application 104 was last executed before migration. The controller 202₃ may access any data associated with the current operation from the container data 206 that is transferred to the memory 204₃. The controller 202₃ may then begin execution of the containerized application 104 in the node 102₃ with minimal delay.

Thus, the nodes 102 of the present disclosure may include the I/O accelerator 106 described above to efficiently migrate containerized applications 104. For example, nodes 102 of the present disclosure may provide for real-time, continuous, and seamless access to persistent data when a containerized application 104 moves across nodes 102. In addition, the I/O accelerator 106 may allow migrated containerized applications 104 to begin execution on the nodes 102 sooner than previously designed computing nodes.

In an example, the nodes 102 may also handle node failures. In case of a node failure, the containerized application 104 on a node 102 may be restarted anywhere within the cluster of nodes 102. For example, when the controller 202 of a node 102 detects a failure, the controller 202 may initiate a drain of the data associated with the containerized application 104 stored in the log 210 for the containerized application 104 on a respective node 102. This process may be relatively quick as the entire log 210 need not be drained, but rather, a subset of the log 210 that includes data associated with the containerized application 104. After the drain, the nodes 102 may start to cache write operations on the local node 102. This may ensure data locality.

In case of a disk failure on a node 102, the controller 202 may drain the log 210 to ensure consistency. Subsequent write operations on that node 102 may be bypassed and redirected to the underlying storage network 108 (e.g., a storage node 212 in the storage network 108). Caching may restart once the disk errors are rectified.

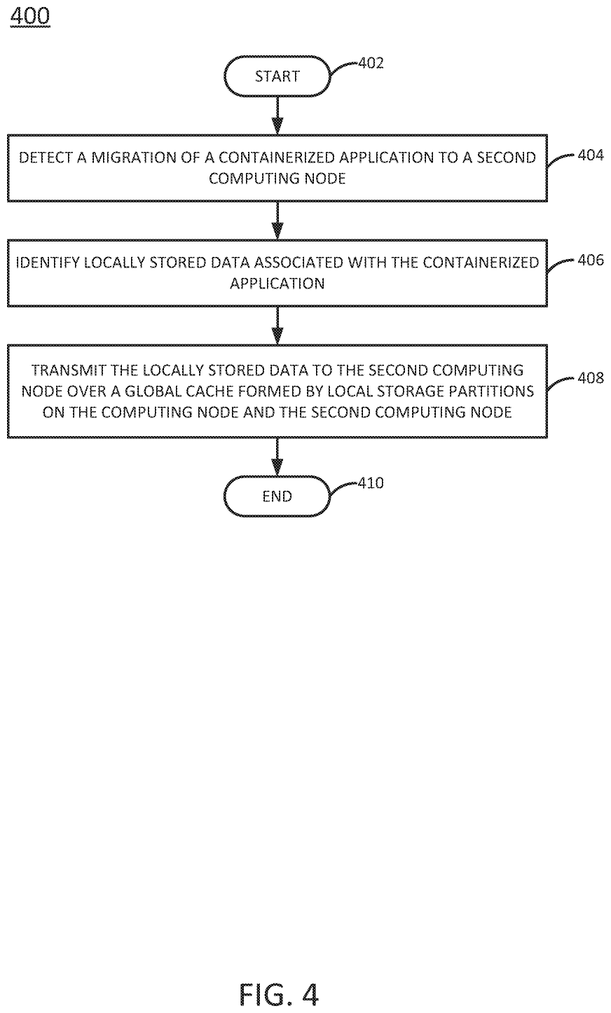

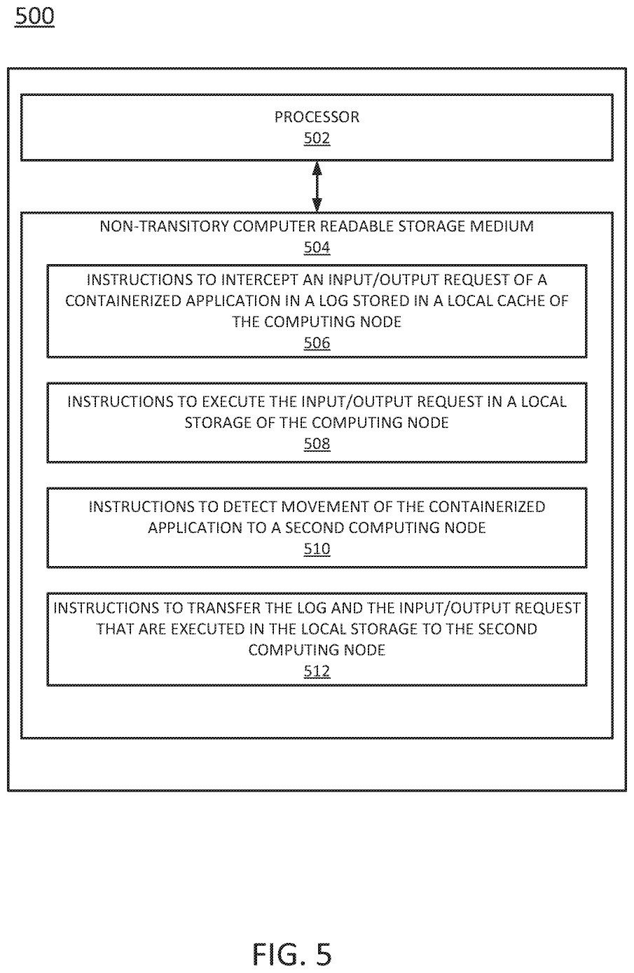

FIG. 4 illustrates a flow diagram of an example method 400 for migrating a containerized application. In an example, the method 400 may be performed by the nodes 102 or the apparatus 500 illustrated in FIG. 5 and described below.

At block 402, the method 400 begins. At block 404, the method 400 detects a migration of containerized application to a second computing node. For example, the containerized application may be migrated for a variety of different reasons, such as for example, load balancing, user requested migration, quality of service requirements, and the like. A target node, or a second computing node, may detect the migration of the containerized application. The containerized application may be migrated to the second computing node in response to the detection of the migration of the containerized application.

At block 406, the method 400 identifies locally stored data associated with the containerized application. In an example, the locally stored data may include container data and a log. The locally stored data may be stored in local memory of the first computing node that was executing the containerized application as the containerized application is being executed.

The container data may include data stored in local memory in response to write commands executed by the containerized application, values used by the containerized application, and the like. The log may maintain a log of input/output operations during execution of the containerized application. The log may identify a current operation being executed by the containerized application. The log may also keep track of where the locally stored data is located in the local memory of the first computing node. For example, the log may track file locations or memory locations of the log itself and the container data as the data is written into local memory.

At block 408, the method 400 transmits the locally stored data to the second computing node over a global cache formed by local storage partitions on the computing node and the second computing node. As discussed above, a portion of the local memory or the local storage partitions may be associated with the global cache. The global cache may allow data associated with the containerized data to be transferred to other computing nodes without accessing a storage network.

For example, the locally stored data may be obtained from local memory locations as identified by the log. The locally stored data, including the log and the container data, may then be transferred over the global cache to the second computing node.

In an example, the first computing node may become the replica node. In other words, after the log and the container data are transferred over the global cache to the second computing node, the second computing node may then continuously update the log on the second computing node as the containerized application is executed on the second computing node. The second computing node may then send updates to the copy of the log stored in the first computing node. At block 410, the method 400 ends.

FIG. 5 illustrates an example of an apparatus 500. In an example, the apparatus 500 may be a node 102. In an example, the apparatus 500 may include a processor 502 and a non-transitory computer readable storage medium 504. The non-transitory computer readable storage medium 504 may include instructions 506, 508, 510, and 512 that, when executed by the processor 502, cause the processor 502 to perform various functions.

In an example, the instructions 506 may include instructions to intercept a input/output request of a containerized application in a log stored in a local cache of the computing node. The instructions 508 may include instructions to execute the input/output request in a local storage of the computing node. The instructions 510 may include instructions to detect movement of the containerized application to a second computing node. The instructions 512 may include instructions to transfer the log and the input/output request that are executed in the local storage to the second computing node.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A computing node, comprising:
a containerized application;
a local storage partition, wherein a portion of the local storage partition is associated with portions of other local storage partitions to form a global cache; and
a controller to execute the containerized application, to receive an indication from a second computing node that the containerized application is being migrated, and to transfer data associated with the containerized application to the second computing node via the global cache.

2. The computing node of claim 1, wherein the local storage partition comprises a log of input/output operations executed by the containerized application.

3. The computing node of claim 2, wherein the log is transferred via the global cache.

4. The computing node of claim 1, wherein the controller is communicatively coupled to a network storage device.

5. The computing node of claim 4, wherein the controller is to periodically transfer the data from the local storage partition to the network storage device.

6. The computing node of claim 1, wherein the controller is communicatively coupled to a second computing node.

7. The computing node of claim 6, wherein a log of input/output operations executed by the containerized application is synchronously replicated at a respective local storage partition of the second computing node.

8. A method, comprising:
detecting, by a processor of a computing node, a migration of containerized application to a second computing node;
identifying, by the processor, locally stored data associated with the containerized application;
transmitting, by the processor, the locally stored data to the second computing node over a global cache formed by local storage partitions on the computing node and the second computing node.

9. The method of claim 8, further comprising:
maintaining, by the processor, a log of input/output operations during execution of the containerized application; and
identifying, by the processor, the locally stored data based on the log.

10. The method of claim 9, further comprising:
transmitting, by the processor, the log via the global cache.

11. The method of claim 9, further comprising:
transmitting, by the processor, the log to the second computing node; and
continuously updating, by the processor, the log on the computing node when changes occur in the log at the second computing node.

12. The method of claim 8, wherein the computing node and the second computing node are associated with a common host operating system.

13. The method of claim 8, further comprising:
identifying, by the processor, files associated with the containerized application in a distributed file system of the computing node; and
transmitting, by the processor, the files associated with the containerized application to a distributed file system of the second computing node.

14. The method of claim 8, further comprising:
transferring, by the processor, the locally stored data to a distributed file system of the computing node periodically.

15. A non-transitory computer readable storage medium encoded with instructions executable by a processor of a computing node, the non-transitory computer-readable storage medium comprising:
instructions to intercept a input/output request of a containerized application in a log stored in a local cache of the computing node;
instructions to execute the input/output request in a local storage of the computing node;
instructions to detect movement of the containerized application to a second computing node; and
instructions to transfer the log and the input/output request that are executed in the local storage to the second computing node.

16. The non-transitory computer readable storage medium of claim 15, wherein the input/output request comprises a write request or a read request.

17. The non-transitory computer readable storage medium of claim 15, further comprising:
instructions to periodically perform a destaging process to move the input/output request that is executed in the local storage to a networked storage device.

18. The non-transitory computer readable storage medium of claim 15, wherein the input/output request is initially intended for a networked storage device.

19. The non-transitory computer readable storage medium of claim 15, wherein the log is continuously transferred to the second computing node that serves as a replica node.

20. The non-transitory computer readable storage medium of claim 15, wherein the log is associated with the containerized application via a containerized application identifier.
